(19) United States
(12) Patent Application Publication
(10) Pub. No.: US 2013/0174050 A1
(43) Pub. Date: Jul. 4, 2013

(54) METHOD AND APPARATUS FOR DOWNLOADING THIRD PARTY CONTENT WITHIN THE SAME WEB PAGE CONTEXT

(71) Applicants: Tommi HEINONEN, Oulu (FI); Tuomas Veli KESKITALO, Oulunsalo (FI)

(72) Inventors: Tommi HEINONEN, Oulu (FI); Tuomas Veli KESKITALO, Oulunsalo (FI)

(73) Assignee: Nokia Corporation, Espoo (FI)

(21) Appl. No.: 13/718,673

(22) Filed: Dec. 18, 2012

Related U.S. Application Data
(60) Provisional application No. 61/581,972, filed on Dec. 30, 2011.

(51) Int. Cl. H04L 29/08; G06F 3/048

(52) U.S. Cl. CPC H04L 67/32; G06F 3/048
USPC 715/748; 709/217

(57) ABSTRACT

An approach is presented for enabling users to download third party content within the same web page context. A content access module determines a request for causing a downloading of content associated with a webpage rendered at a device, wherein the content is hosted at at least one content store. A rendering of information associated with the content, the downloading of the content, or a combination thereof from the at least one content store as a sub-element of the webpage, is caused. The content access module then determines to cause, at least in part, the downloading of the content to the device, one or more other devices, or a combination thereof within a context of the webpage.

### RELATED APPLICATIONS

This application claims the benefit of the earlier filing date under 35 U.S.C. §119(e) of U.S. Provisional Application Ser. No. 61/581,972 filed Dec. 30, 2011, entitled “Method and Apparatus for Downloading Third Party Content Within the Same Web Page Context,” the entirety of which is incorporated herein by reference.

### BACKGROUND

Network service providers and device manufacturers are continually challenged to deliver value and convenience to consumers by, for example, providing compelling network services. One area of particular interest is enhancing the ability of a user to seamlessly access and download online content such as games, music and applications via a browser application. Typically, when a user of a device visits a web page of interest, content to be accessed by the user in relation to the web page is accessed by way of a web link. For example, the web link specifies the network location of the content or a content store wherein the content may be accessed. Upon clicking the link, a separate browser window or tab is spawned for enabling the user to view and/or access the content store, thus directing the user away from the web page of interest. Unfortunately, providers of web pages have no way to link content provided by a third party provider to their webpage without redirection or exit by the user.

### SOME EXAMPLE EMBODIMENTS

Therefore, there is a need for an approach for enabling users to download third party content within the same web page context.

According to one embodiment, a method comprises determining a request for causing a downloading of content associated with a webpage rendered at a device, wherein the content is hosted at at least one content store. The method also comprises causing, at least in part, a rendering of information associated with the content, the downloading of the content, or a combination thereof from the at least one content store as a sub-element of the webpage. The method further comprises determining to cause, at least in part, the downloading of the content to the device, one or more other devices, or a combination thereof within a context of the webpage.

According to another embodiment, an apparatus comprises at least one processor, and at least one memory including computer program code for one or more computer programs, the at least one memory and the computer program code configured to, with the at least one processor, determine a request for causing, at least in part, a downloading of content associated with a webpage rendered at a device, wherein the content is hosted at at least one content store. The apparatus is also caused to render information associated with the content, the downloading of the content, or a combination thereof from the at least one content store as a sub-element of the webpage. The apparatus further determines to cause, at least in part, the downloading of the content to the device, one or more other devices, or a combination thereof within a context of the webpage.

According to another embodiment, a computer-readable storage medium carries one or more sequences of one or more instructions which, when executed by one or more processors, cause, at least in part, an apparatus to determine a request for causing, at least in part, a downloading of content associated with a webpage rendered at a device, wherein the content is hosted at at least one content store s. The apparatus is also caused, at least in part, to render information associated with the content, the downloading of the content, or a combination thereof from the at least one content store as a sub-element of the webpage. The apparatus is further caused to determine to cause, at least in part, the downloading of the content to the device, one or more other devices, or a combination thereof within a context of the webpage.

According to another embodiment, an apparatus comprises means for determining a request for causing, at least in part, a downloading of content associated with a webpage rendered at a device, wherein the content is hosted at at least one content store. The apparatus also comprises means for causing, at least in part, a rendering of information associated with the content, the downloading of the content, or a combination thereof from the at least one content store as a sub-element of the webpage. The apparatus further comprises means for determining to cause, at least in part, the downloading of the content to the device, one or more other devices, or a combination thereof within a context of the webpage.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling users to download third party content within the same web page context, according to one embodiment;

FIG. 2 is a diagram of the components of a content access module, according to one embodiment;

FIG. 3A is a flowchart of a downloading process of the content access module, according to one embodiment;

FIG. 3B is a ladder diagram depicting an interaction between various components of the system of FIG. 1 for facilitating a downloading of content, according to one embodiment;

FIGS. 4A-4D are flowcharts of processes performed by the content access module of FIG. 2 according to various embodiments;

FIGS. 5A-5C are diagrams of user interfaces for enabling users to download third party content within the same web page context, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for enabling users to download third party content within the same web page context. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

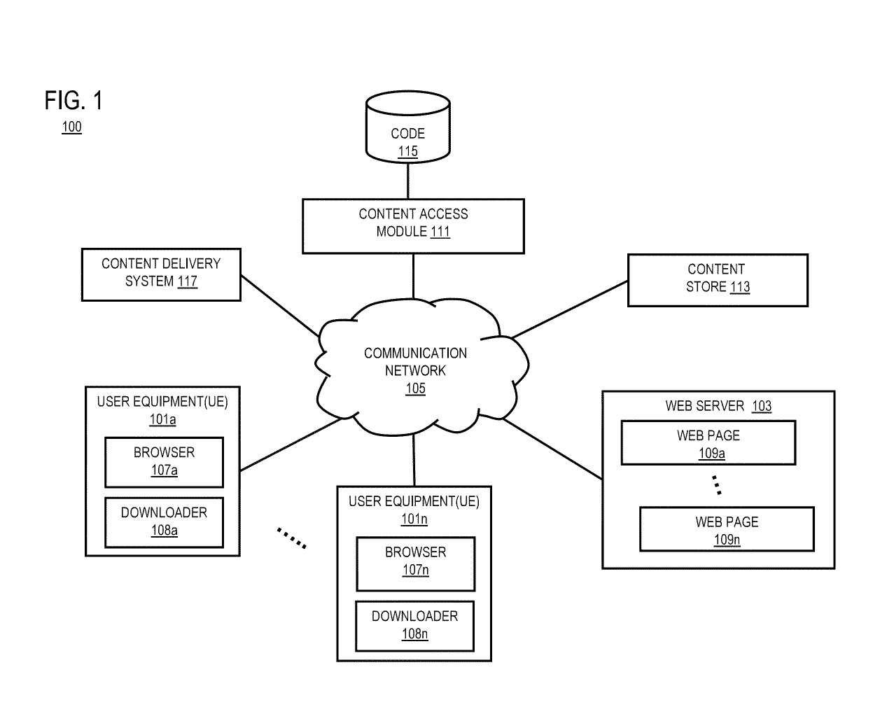

FIG. 1 is a diagram of a system capable of enabling users to download third party content within the same web page context, according to one embodiment. The system includes a content access module 111 for interacting with various devices, including user equipment (UE) 101a-101n, to permit seamless downloading of content from a content store to one or more of the devices. By way of example, third party content pertains to content that is provided by, hosted by or made available for access by an entity, provider, or other host other than the publisher of a web page 109 being accessed by a user at a given moment. As noted previously, users visiting a website may at times need to access content from a content provider, i.e., such as a content store that hosts content. By accessing the content store, the user can download music, media, applications, and any other data capable of being accessed, retrieved, downloaded, or otherwise executed by a calling application such as a web browser, device operating system, or the like.

Oftentimes, the content to be downloaded is related to the web page being visited at the moment, such as in the case where a web page of a application provider (the publisher) requires a user to download another application provided by a device manufacturer (the content provider) in order for the publisher's application to operate on the user's device. Typically, the link featured at the web page for accessing the external content causes the context of the web page to change; the user is no longer interacting with the web page from which they invoked the download request.

Unfortunately, changing context within the browser application diminishes the overall user experience. When a context change occurs, the user must toggle between separate browser windows or different tabs within the browser to get back to the original web page they were viewing. In certain instances, the user may even be forced to press the “BACK” button of their browser in order to view the web page they had since been exited or redirected from as a result of the link. Still further, it is preferential to the provider of the web page (the publisher) that the user is able to access external content without having to navigate away from their page. However, publishers of web pages currently have no convenient means of linking content provided by a third party content provider to their webpage without causing a browser context change (e.g., redirection to another site or exit from the original browser window).

To address this problem, a system 100 of FIG. 1 introduces the capability to allow publishers of online content to readily configure their web pages 109a-109n with one or more interactive elements for permitting seamless downloading of external content. Seamless downloading may include, for example, the facilitation of a download process wherein the download is not visible to the user of a requesting device or one or more other devices targeted for receipt of the download. Furthermore, the download is not performed in an independent user interface context, but within context of the page at which the download process was initiated (e.g., the publisher's web page). In certain embodiments, the one or more interactive elements may include a button, a slide rule, a knob, a data input field, a voice prompt, or any other tool capable of being interacted with by a user directly from a user interface (e.g., a browser window). For the purpose of illustration, the interactive element as presented herein is a button, which upon selection facilitates downloading of content from a content store. The download process is performed such that the web page(s) 109a-109n featuring the interactive element, i.e., button, remains in view of the user and within the same context even while the download commences.

By way of example, a service provider A may host a web server 103 for publishing various web pages 109a-109n. The web pages are retrieved by user equipment 101a-101n via a communication network 105, such as by entering the network address of the web service in a browser application 107 of the UE 101. The web pages 109a-109n developed by service provider A may feature various text, images, forms and other elements related to the service provider, including products offered by the provider, opinions, ratings information, or the like. Service provider A may also want to enable visitors of their web pages 109a-109n to access and download content made available at a content store 113 hosted by a content provider B. In certain instances, content provider B may be a strategic partner of service provider A (the publisher), may host supporting content required by or related to various service offerings of service provider A, may host content recommended by service provider A, etc.

Under this scenario, to facilitate the download process from within a context of their web page 109, the web page 109 features one or more interactive elements (e.g., buttons) as provided by a content access module 111. The buttons are embedded within the code and/or scripting language used to generate the web page 109 (e.g., hypertext markup language, extensible hypertext markup language). As such, the buttons may be activated (e.g., selected) by the user via the browser application 107, which upon selection causes execution of a modal dialog or modal window. In contrast to a separate browser window, browser tab, or redirection, the modal window is a child window that requires user interaction (e.g., input or selection) before permitting continued operation of the web page 109 from which the button was selected. In certain embodiments, the modal window appears as a sub-element of the web page from which it was called, and may be caused to appear atop, in alignment with, overlaid upon, or otherwise featured within context of the calling webpage accordingly. It is noted that the button provided by the content access module 111 permits execution of the modal dialog as well as facilitates the rendering of information related to the content to be downloaded.

Still further, the one or more interactive elements (e.g., buttons) facilitate a downloading of the content directly from the content store 113 by way of user response to and selection of various downloading options presented in connection with the modal window. For example, one download option may include an option for the user to download content to an intermediate device, such as personal computer (PC) that features a downloader 108a. Alternatively, the intermediate device can be an alternate mobile device of the user or a device of a friend. In this scenario, the downloader 108a may reside on the intermediate device for facilitating transference of downloaded content to a connected mobile device. The connection may be facilitated by way of a universal service bus (USB) connection, infrared connection, Bluetooth connection, or other device-to-device connectivity mechanism. It is noted that the downloader 108a-108n of respective UE 101a-101n may be dedicated software tool or an ancillary component of an existing software tool operable at the UE 101a-101n.

Another download option made available via the modal window is an over-the-air download option. By way of example, this may include pushing of the content to the mobile device directly via the communication network 105 (e.g., push notification), dropping of the content or an executable link thereto to the device, real-time downloading, or the like. A content delivery system 117 may be invoked in connection with the download process—i.e., as facilitated by the content access module 111 and/or content store 113—for supporting the wireless download process via the communication network 105.

In certain embodiments, the download option may be user selected or selected on a conditional basis. For example, only one of the options may be shown in response to a determined device capability and/or limitation. Under this scenario, when it is determined that a wireless data connection is not available, on the direct connection option is presented while limited availability of (or presence) of a device connection port (e.g., USB) for a device causes only the wireless download option to be presented. It is noted that for any of the download options, the content delivery system 117 and downloader 108 may operate independently or in conjunction with one another to deliver content to a device, i.e., UE 101, as retrieved from the content store 113.

Still further, the content access module 111 may be configured to enable automated execution of downloaded content per the various settings of the device to which it is procured/stored. For example, this may include automated installing of the downloaded content, automated playback of the content, automated rendering of the content via a calling and/or compatible application at the device, or the like. The user may establish various settings for adapting the auto execution features.

The modal window rendered to the user interface as a sub-element of the webpage may also feature various information regarding the content to be downloaded subject to the various download options. For example, the information may include a description of the content to be downloaded, a customer and/or satisfaction or product popularity rating, pricing information, one or more images for depicting the content provider of the content, etc. By presenting this information, the modal window invoked by selection of an interactive element serves as a preview window for informing the user of the content selection related to the interactive element they selected. In certain embodiments, the content access module accesses an application programming interface and/or content profile information related to the content provider for generating the preview information. While only a single content store is shown, it is contemplated that multiple different content stores may be invoked in association with an interactive element as embedded within a web page 109 provided by the web server 103.

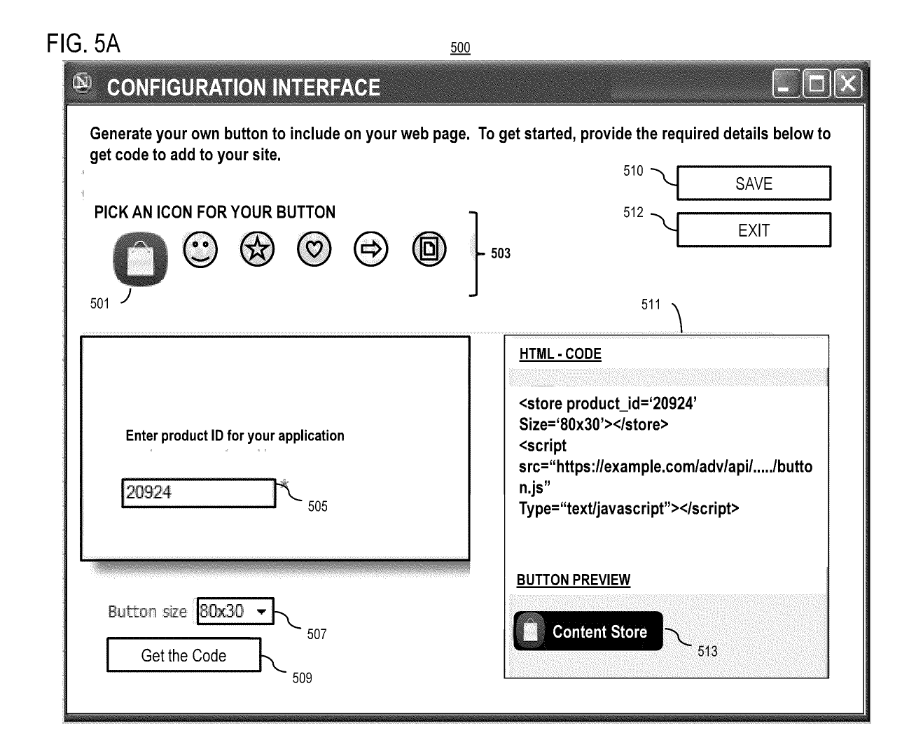

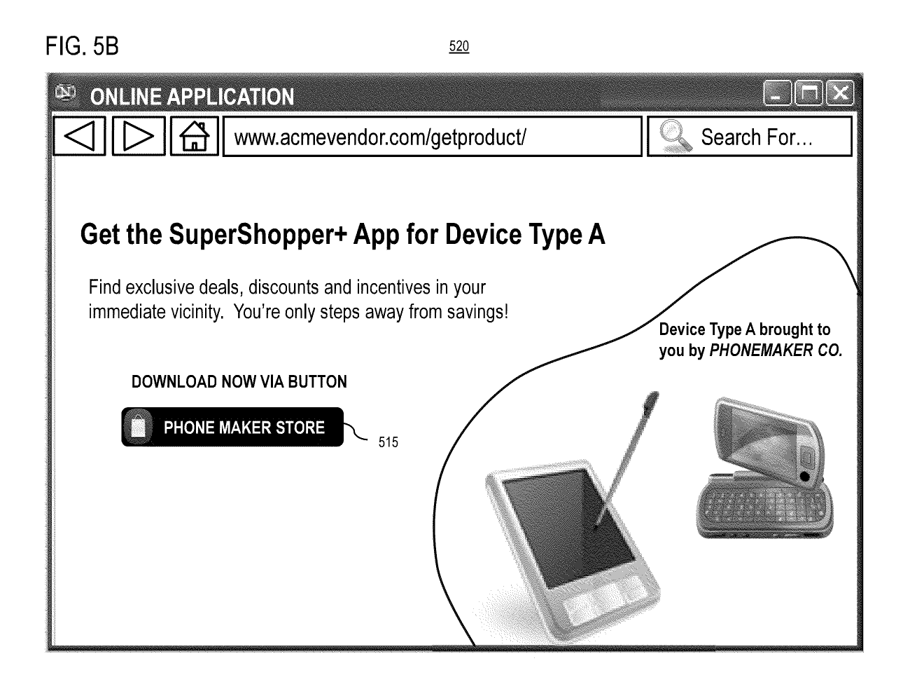

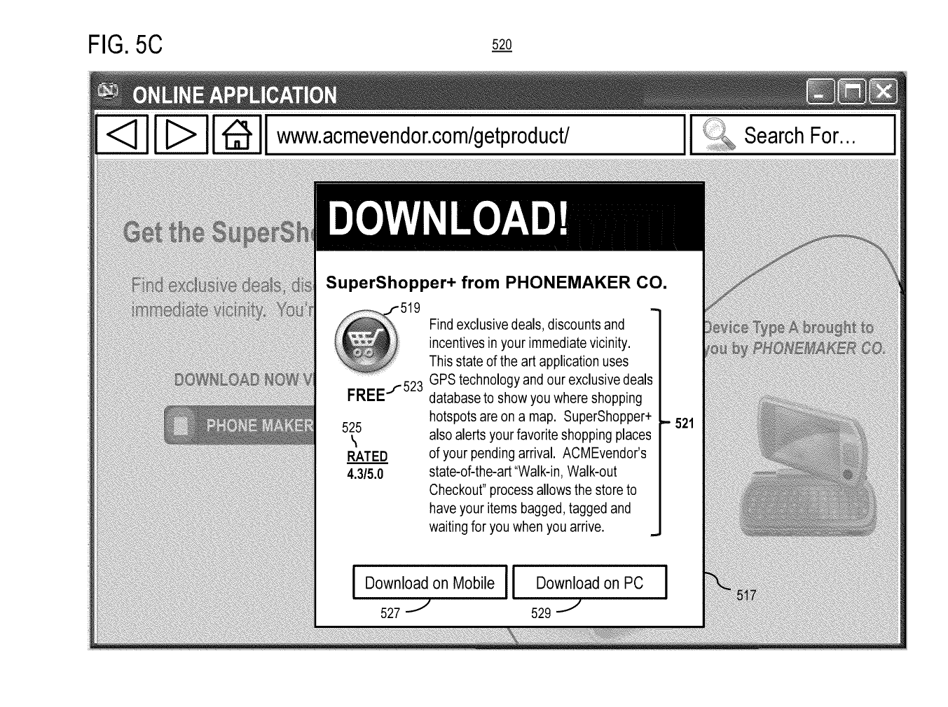

In certain embodiments, the content access module 111 provides a configuration interface for enabling a developer, host, webmaster, or the like associated with the web server 103 to embed the code 115 required to invoke one or more interactive elements into the web pages 109a-109n. By way of example, the configuration interface is accessed via a browser of a UE 101 and includes various buttons, customization tools and other elements integrate a direct download link to content at the content store 113 directly from a web page 109. The configuration interface is illustrated more fully later on, by way of example, with respect to FIGS. 5A-5C. code 115. For the purpose of illustration, the code 115 may conform to various scripting languages and protocols for accommodating different device types, operating systems, browser configurations, network configurations and the like. In addition, the code may include run-time and/or device or browser executable language, may call to specific executable language as maintained by the content access module or another source, or a combination thereof.

In certain embodiments, the content access module 111 operates in connection with or upon UE 101a-101n for facilitating the seamless downloading of content hosted at a content store 113 via one or more web pages 109a-109n. By way of example, the content access module 111 enables one or more of: (1) a developer, host, programmer or other online provider associated with a web server 103 to integrate at least one interactive element for initiating the content downloading process into any of their web pages 109a-109n; (2) a user of UE 101 to directly initiate a download of content at the content store by way of the interactive element via various download options; (3) manage the interaction between the content delivery system 117, a downloader 108 at a device and the content store 113 for fulfilling the download request. It is noted that the content access module 111 also performs an authentication and validation process for ensuring managed and secure execution of the download procedure.

The content access module 111 may provide a direct link to the content associated with the web page 109 being accessed by the user at a given moment via a browser application 107. As such, a first web page 109a may feature a button as configured by the content access module 111 for linking to a first set of content while a second web page 109n may feature an identical button, but that links to a second set of content. The configuration interface enables the user to specify the particular content to link to via content profile data provided by the content store and maintained by the module 111.

As shown in FIG. 1, the system 100 comprises a user equipment (UE) 101 having connectivity to the content access module 111, content delivery system 117, content store 113 and web server 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, content access module 111, content delivery system 117, content store 113 and web server 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

While shown as separate components, it is contemplated in certain embodiments that the content delivery system 117, content access module 111 and downloader 108 may be integrated to accommodate differing content delivery requirements and network requirements. For example, the content delivery system 117 employed by or required by one content store 113 for facilitating over-the-air downloading may differ than that of another content store. As another example, the downloader 108 may be integrated directly by the content access module for facilitating receipt of downloaded content pursuant to a download request invocation. Still further, the content delivery system 117 may be integrated within the content access module 111 for facilitating the download process directly upon download request invocation (e.g., selection of an interactive element and subsequent download option by a user of UE 101). The exemplary embodiments herein contemplate any existing or future approaches.

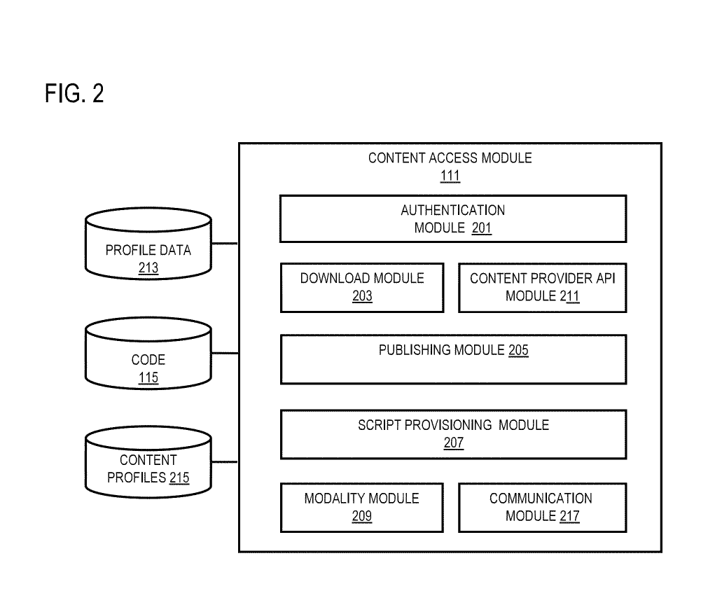

FIG. 2 is a diagram of the components of a content access module, according to one embodiment. By way of example, the content access module 111 includes one or more components for enabling users to download third party content within the same web page context. In addition, the content access module 111 includes one or more components for enabling online providers—i.e., web server hosts—to publish web pages that feature interactive elements for facilitating a seamless download of third party content. It is contemplated that the functions of these components may be combined in one or more components or performed by other components of equivalent functionality.

In this embodiment, the content access module 111 includes an optional authentication module 201, a download module 203, a content provider application programming interface (API) module 211, a publishing module 205, a script provisioning module 207, a modality module 209 and a communication module 217. In addition, the content access module 111 maintains various databases 213, 115 and 215 for accessing various data to support execution of the above described modules. This includes, for example, profile data 213 regarding the various users and/or publishers that employ the content access module 111, code 115 for being embedded into a web page of a publisher and content profile data 215 related to the various content made available by one or more content providers at one or more content stores.

By way of example, the content access module 111 includes the authentication module 201 for embodiments in which authentication is requested or required. In embodiments, where no authentication is needed, the content access module 111 need not include the authentication module 201. In the example of FIG. 2, the authentication module 201 authenticates users and user devices 101a-101n for interaction with the content access module 111. This may include both device users who may access a particular web page of a publisher or web server 103 host as well as the publisher themselves. By way of example, the authentication module 201 receives a request to subscribe to or activate the content access module 111 at a device of a user for facilitating the download process. This may include, for example, the downloading and activating of a downloader to the user device for enabling storage of downloaded content or transference of content from an intermediate device (e.g., another mobile device or a PC). In addition, the authentication module 111 may be activated for use in connection with a publisher for enabling activation of a configuration interface for generating one or more interactive elements. The subscription or activation process may include the defining of various preferences and settings, such as device settings and capabilities, content selection preferences, network configuration and/or download preferences, etc. In addition, payment options may also be established by the user for facilitating purchase of content (when required). For example, the user may opt in for one click payment authorization. Still further, the user may establish one or more automated downloading or installation settings. The settings information may be referenced to a specific user, user device, publisher, or combination thereof, and maintained as profile data 213.

The authentication process performed by the module 201 may also include receiving and validating a login name and/or user identification value as provided or established for a particular user during a subscription or registration process with the content store 113, the web server 103, or a combination thereof. The login name and/or user identification value may be received as input provided by the user from the user device 101 or other device (e.g., the publisher's PC) via a graphical user interface to the web server 103 (e.g., as enabled by publishing module 205). Profile data 213 may be cross referenced as part of the login process. Alternatively, the login process may be performed through automated association of profile 213 with an IP address, a carrier detection signal of a user device, mobile directory number (MDN), subscriber identity module (SIM) (e.g., of a SIM card), radio frequency identifier (RFID) tag or other identifier.

Still further, the authentication module 201 may also be configured to perform validation, an authentication, or a combination thereof of the web page, the content, the at least one content store, or combination thereof. This validation may include determining a proper maintenance of a content provider API module 211 and/or content profile data 215 for respective content stores and associated content, determining the authenticity of one or more web pages made available by the publisher, etc. It is contemplated that the content provider API module 211 provides access to functions of the system 100 by first party content stores as well as any other content or content providers available over the communication network 105. In addition, the authentication module 201 determines status information regarding a downloading and/or installation of downloaded content. This may include determining if any compile or load errors occurred at the device. In addition, web pages, content or one or more content stores may be compared against blacklists or whitelists for enabling the authentication and/or validation.

In one embodiment, the download module 203 enables users to download content via a content delivery system 117, such as a push notification system, drop server, etc., to their device and/or devices. In addition, the download module 203 supports execution of the downloader 108 at UE 101. For the purpose of illustration, the download module 203 facilitates an exchange between the downloader 108, content delivery system 117 and the content access module 111 with the content store 113. Alternatively, the download module 203 operates in place of, or as the content delivery system 117 and/or downloader 108 in connection with a requesting UE 101. In certain embodiments, the downloader may retrieve content in accordance with the specific requirements of the device to which the content is to be delivered—i.e., based on different operating system types, device types, markets, etc.

When a download request is initiated, the download module 203 triggers activation of the downloader 108 or content delivery system 117 depending on the chosen download option to facilitate the content transfer process. This may include interfacing with a drop server or push notification system for over-the-air downloads or activating the downloader 108 in response to a PC/USB connection. By way of example, in the case of a drop server, the download module 203 activates the server, which in turn provides (drops) a resource locator for referencing the content to the mobile device. The content as referenced is then transferred over the air exchange by reference to the resource locator at the device.

The download module 203 uses the content profile information 215 retrieved by the content provider API module 211 to generate a modal window in connection with a publishing module 205. Hence, the download module 203 receives the input to the window corresponding to the download option, and provides this selection option to the content provider API module 211 and publishing module 205 accordingly. As noted previously, the download module 203 supports various content delivery approaches, including over-the-air content delivery, push delivery, intermediate device/direct connection based schemes, dedicated download client schemes, and the like.

Also operating in connection with the download module 203 is the modality module 209, which determines the current status of a modal window presented to a user. By way of example, the modality module 209 enforces the modal window execution pursuant to receipt of a proper input from a user (e.g., download option selection, cancel); thus preventing further execution of the web page from which the window was called until proper response is acquired. As such, the modality module 209 determines and maintains the current context/mode of the web page from which a download request dialog was initiated.

In one embodiment, the content provider API module 211 causes the generation of a modal window in response to selection of an interactive element (e.g., button) for initiating a download process from a web page of a publisher. In addition, the content provider API module 211 provides information regarding the content to be associated with the modal dialog. It is noted that the content provider API module 211 accesses content profile data 215 for facilitating creation of a modal window. For example, the profile data 215 may include a content identifier, content rating information for indicating the popularity or effectiveness of the content, a description of the content, etc. It is noted that a content profile 215 may be associated with each set of content made available for download (by a merchant/content provider). Furthermore, the content profile data 215 may be referenced by or associated with profile data of a registered publisher and/or content provider accordingly.

Hence, module 211 enables presentment of a user interface elements in response to application programming interfaces (APIs) or other function calls corresponding to the browser application 107, the content store 113, the web server 103, etc.; thus enabling the display of graphics primitives, some of which are interactive or visual in nature.

In one embodiment, the publishing module 205 enables publishers to access a configuration interface for configuring and generating their own interactive elements for inclusion in their web pages. By way of example, the interface provides various buttons, customization tools and other features for enabling a publisher to customize their interactive elements as well as to integrate them. This is illustrated more fully, by way of example, with respect to FIG. 5A. The publishing module may also be configured to operate in connection with the API of a calling device for enabling rendering of the configuration interface accordingly. In one embodiment, the script provisioning module 207 provides code to a requesting publisher for enabling integration of the interactive user interface element (e.g., a button) into the publisher's web page. By way of example, the code includes one or more instructions for linking to the content in the content store, rendering one or more user interface elements to indicate the linking, or a combination thereof. Still further, for certain implementations, the script provisioning module 207 may be configured to automatically integrate the script into existing web page content of the publisher. This may include, for example, encoding of the script as an object comprising the necessary code 115, along with object interfaces for direct connection with a complimentary interface element of the web page. Under this approach, the script provisioning module 207 accesses profile data 213 for indicating one or more object interfaces or types established for automating the integration process by the publisher. Once the object is generated, it is delivered to the web server and processed and/or compiled accordingly.

In one embodiment, a communication module 217 enables formation of a session over a network 109 between the content access module 111 and the web server 103, content delivery system 117 and one or more content stores 113. By way of example, the communication module 217 executes various protocols and data sharing techniques for enabling collaborative execution between a subscriber's user device 101a-101n (e.g., mobile devices, laptops, smartphones, tablet computers, desktop computers) and the module 111 over the network 105.

The above presented modules of the content access module 111 can be implemented in hardware, firmware, software, or a combination thereof. Though depicted as a separate entity in FIG. 1, it is contemplated that the content access module 111 may be implemented for direct operation by respective UEs 101a-101n. As such, the content access module 111 generates direct signal inputs by way of the operating system of the UE for interacting with the browser application 107 and accessing content. In another embodiment, one or more of the modules 201-217 may be implemented for operation by respective UEs as a platform, a hosted (e.g., cloud based solution), or combination thereof.

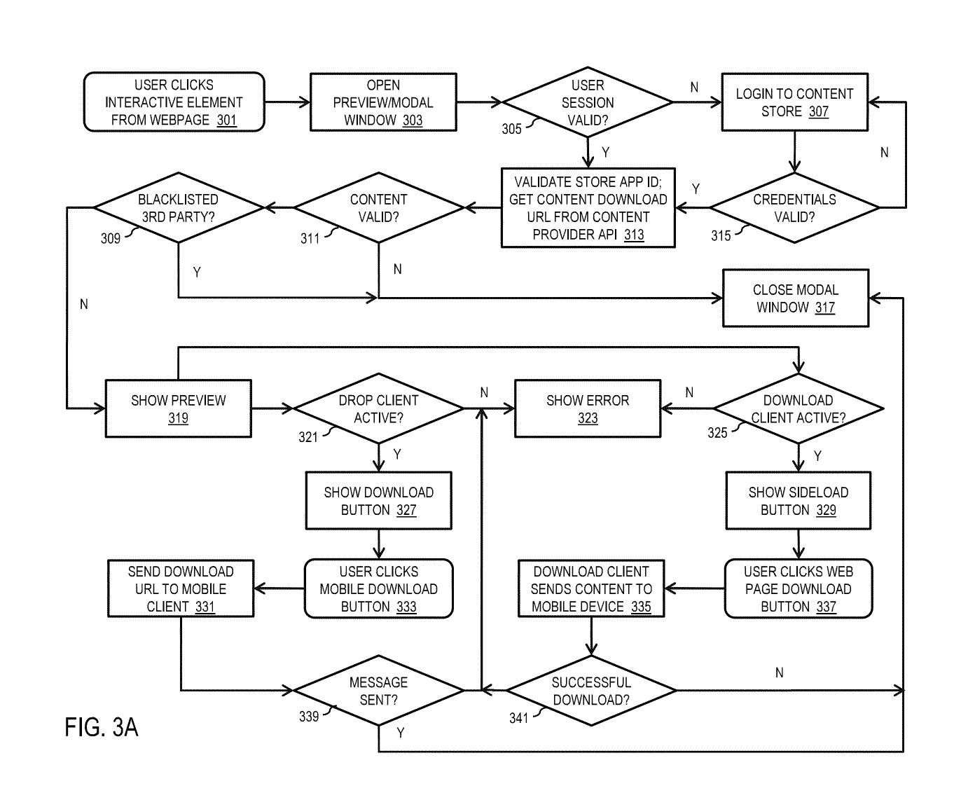

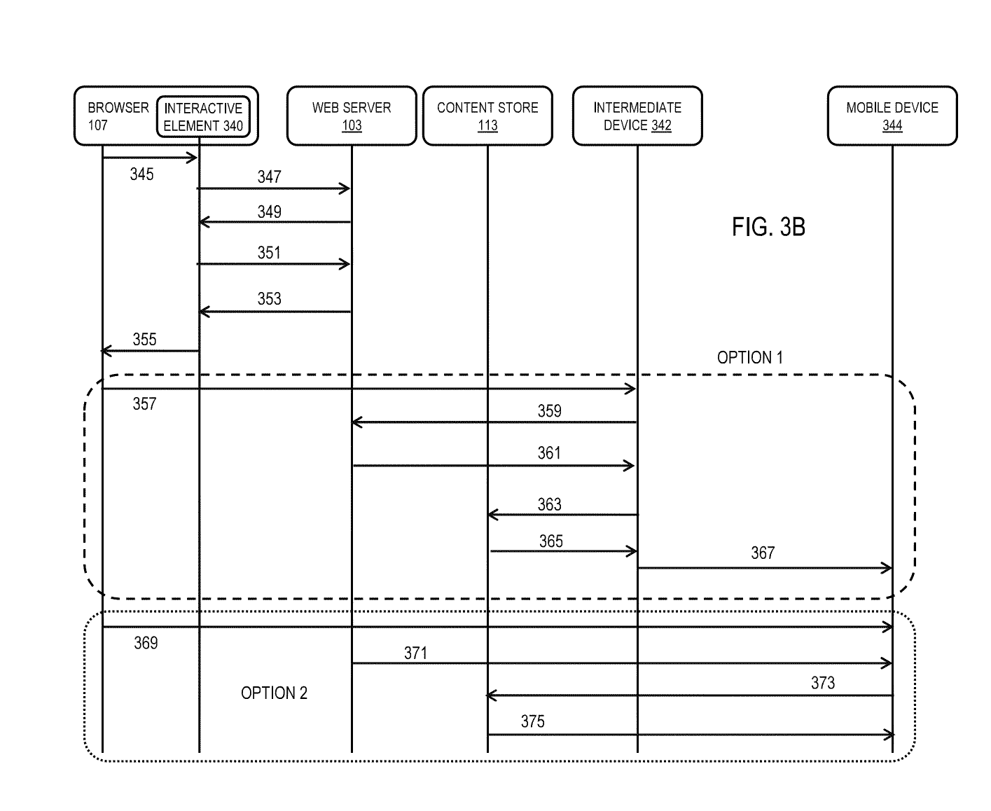

FIG. 3A is a flowchart of a downloading process of the content access module, according to one embodiment. In steps 301 and 303, the user clicks an interactive element that is embedded in a web page of a publisher 301, causing the invoking of a preview/modal window. The preview/modal window may include information for providing details regarding the content to be downloaded, pricing information, rating information, etc. In step 305, a check is performed to determine the validity of the user session—i.e., for accessing of the content, the content store(s), or the web pages of the publisher. When the session is determined not to be established, the login process is initiated per steps 307 and a validation is performed per step 315. When determined valid, per step 313, the content/application identifier is verified and the download resource locator (e.g., URL) is downloaded. This is performed by the content provider API module 211 of FIG. 2.

In step 311 and 309, the content as downloaded is validated and further compared against a blacklist. When determined to match the blacklist or determined invalid, the modal window is closed per step 317. Otherwise, as shown in step 319, the preview is shown and a connectivity determination is performed, per steps 321 and 325. Step 321 corresponds to a determining of registration/availability/activation of a drop client for enabling over-the-air downloading while step 323 corresponds to downloading to an intermediate device via a downloader 108. When the connectivity status is not active, an error message 323 is presented to the user. Otherwise, when at least one of the connections is determined, the download button for that particular connection type is presented, corresponding to steps 327 and 329. Hence, in the case of a valid network connection, only the over-the-air download button is shown while the other download option button is masked out.

In steps 333 and 337, the user clicks the mobile download button (over-the-air) or web page download button (PC/USB) respectively. In step 331, the content access module then sends the download URL to the mobile device for facilitation of the over-the-air delivery—i.e., accessing of a drop server or other content delivery system 117. In step 335, the downloader receives the content per the download module of the content access module 111. A determination as the success processes 331 and 335 is then performed, per steps 339 and 341 accordingly. When successful downloading is determined, the modal window is then closed per step 317, thus enabling the user to once again operate the web page of the publisher. It is noted that the web content featured by the page may be masked out during invocation of the modal window as a sub-element of the web page.

FIG. 3B is a ladder diagram depicting an interaction between various components of the system of FIG. 1 for facilitating a downloading of content, according to an exemplary embodiment. For the purpose of illustration, the browser application 107 (for providing a device user interface) is shown to include an interactive element 340, which is shown in response to accessing of the web server 103 featuring various web pages. As noted, the web pages have embedded within its source code the necessary code 115 for enabling execution and presentment of the interactive element (button) 340.

In step 345, the user clicks the download button at the web page. In the context of the HTTP protocol, this results in sending of an authentication request (e.g., HTTP GET) and a return authentication response from the web server 103. This corresponds to steps 347 and 349 respectively. In steps 351 and 353, a download request (e.g., HTTP POST) that includes the download URL is sent to the server which provokes a response from the server 103 (e.g., 200) for indicating the download request has been stored. A subsequent feedback message may also be presented to the user via the browser 107 per step 355.

As noted previously, the different download options pertain to different executions. When the download option is to facilitate the download via an intermediate device 342 (OPTION 1), the user (or optionally the content access module 111) may initiate the downloader 108. In addition, the user may connect the mobile device 344 for which the content is destined to the intermediate device 342. The connection may be formed by way of a USB connection or other physical connection type.

In steps 359 and 361, the downloader 108 performs a check to see if there is new content available and then the web server 103 delivers the stored content to the intermediate device 342. This causes the intermediate device to download content from the content server (the content store 113) in accordance with the provided stored URL, per step 363. In steps 365 and 367, the content store 113 then provides the required content to the intermediate device 342, and downloader then delivers (stores) the content to the mobile device 344 via the physical connection between the mobile device 344 and the intermediate device 342.

When OPTION 2 is selected, in step 369 the user launches the mobile device 344 and connects the mobile device to the communication network 105. In steps 371 and 373, the stored content is then delivered to the mobile device 344 and the mobile client downloads the content from the content store 113 over-the-air. Of note, the content delivery system 117 may facilitate the delivery of the content in connection with the content access module 111, web server 103, content store 113, or a combination thereof. Per step 375, the content store then provides the content (e.g., drops or pushes it) to the mobile device accordingly 344.

In certain embodiments, the download process facilitated by the content access module 111 may also be implemented in connection as a cloud based solution. By way of example, the content access module 111 provides the necessary information (e.g., content description, ratings) about the content for constructing a preview age for access by a user via a device. This information is then used to construct the preview and stored to a cloud based server (not shown). By way of this approach, all downloads are stored to the cloud and delivered either via an intermediate device over-the-air. The user can download content from the cloud based server via the downloader 108 (e.g., USB cable) by way of the following process: (a) the intermediate device 342 retrieves the content from the cloud; (b) downloads content from content access module (e.g., via the content provider API module 211; (c) then the downloader transfers the content to the mobile device 344.

Alternatively, the user can download content from cloud based server over-the-air by way of the following: (a) client delivery system (not shown) gets notification that there is content available on the cloud; and (b) the content delivery system downloads content via the content access module 111 (e.g., via the content provider API module 211).

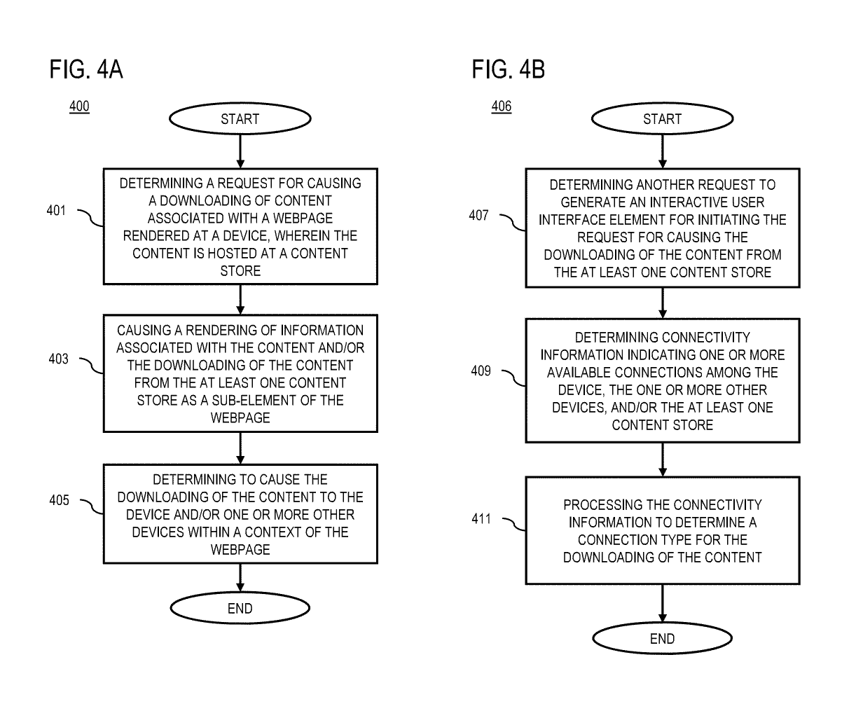

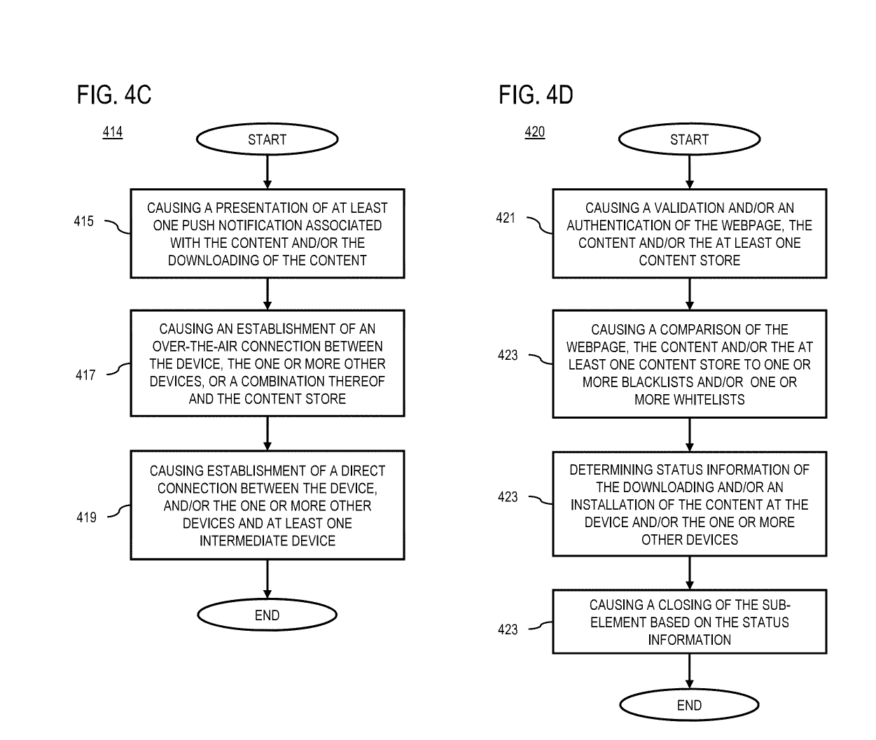

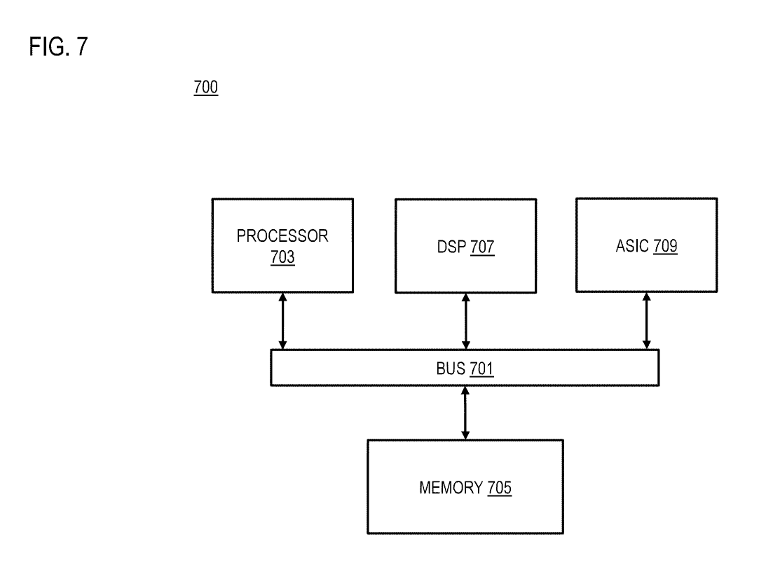

FIGS. 4A-4D are flowcharts of processes performed by the content access module of FIG. 2 according to various embodiments. In one embodiment, the content access module performs processes 400, 406, 414 and 420 and is implemented in, for instance, a chip set including a processor and a memory as shown in FIG. 7.

In step 401 of process 400 (FIG. 4A), the module 111 determines a request for causing a downloading of content associated with a webpage rendered at a device, wherein the content is hosted at a content store. In another step 403, the module causes a rendering of information associated with the content and/or the downloading of the content from the at least one content store as a sub-element of the webpage. As noted, the information may include information for previewing the content, and is rendered within context of the web page rendered at the device. In step 405, the module determines to cause the downloading of the content to the device and/or one or more other devices within a context of the webpage.

In step 407 of process 406 (FIG. 4B), the module 111 determines another request to generate an interactive user interface element for initiating the request for causing the downloading of the content from the at least one content store. The interactive user interface element is inserted into the webpage, and in certain embodiments, includes, at least in part, code for (a) a linking to the content in the content store; (b) rendering one or more user interface elements to indicate the linking; or (c) a combination thereof. Per step 411, the module 111 processes the connectivity information to determine a connection type for the downloading of the content. As noted previously, this determination process enables the modal window as presented via the browser application 107 to be consistent with the current status of the device. Hence, only those download options pertinent to the device at the current moment are presented.

In step 415 of process 414, the module 111 causes a presentation of at least one push notification associated with the content and/or the downloading of the content. In another step 417, the module 111 causes an establishment of an over-the-air connection between the device, the one or more other devices, or a combination thereof and the content store. Still further, per step 419, the module 111 causes establishment of a direct connection between the device, and/or the one or more other devices and at least one intermediate device. By way of example, the at least one intermediate device downloads the content from the at least one content store and causes, at least in part, a transfer of the content to the device, the one or more other devices, or a combination thereof from the intermediate device via the direct connection. It is noted, per steps 415-419, that the various download options are enabled based on user selection or based on determined connectivity status.

In step 421 of process 420, the module 111 causes a validation and/or an authentication of the webpage, the content and/or the at least one content store. In step 423, the module 111 then causes a comparison of the webpage, the content and/or the at least one content store to one or more blacklists and/or one or more whitelists. By way of example, the whitelists may be used for determining valid or preferred content items while blacklists are used for restricting or banning specific content items. The validation, the authentication, or a combination thereof as per step 421 is based, at least in part, on the comparison. Per steps 423 and 425, the module 111 then determines status information of the downloading and/or an installation of the content at the device and/or the one or more other devices and causes a closing of the sub-element based on the status information. By way of example, the sub-element is a modal dialog rendered in at least one frame of the webpage.

FIGS. 5A-5C are diagrams of user interfaces for enabling users to download third party content within the same web page context, according to various embodiments. The diagram corresponds to a configuration management interface 500, which may be accessed by a publisher that is subscribed to or actively engaged to user the content access module 111.

The configuration management interface 500 includes various icon selection options 503 for customizing the visual depiction of the interactive element, which in this example is a button. The interface also features a data entry field 505 for enabling the publisher to input a product and/or content identifier. The content identifier value, when entered, may be validated and cross referenced against content profile information for ensuring a match. By way of example, when the user selects icon 501, the content access module 111 updates the content profile maintained for product identifier 20924 per the data entry field 505.

A button size may also be selected via a drop down menu for further customizing the appearance of the button at the web page. While not shown in this example, various additional menus may be provided for enabling the user to alter the color scheme, font size, font type, rotation and other aesthetic qualities of the button. When the user selects the Get the Code action button 509, the code 511 corresponding to the selected parameters is generated and/or retrieved by the content access module 111 and presented to the user. The corresponding button 513 associated with the code is also presented as a preview.

Once the user is finished, they can save the button by selecting the SAVE action button 510 or exit the configuration interface 500 by selecting the EXIT action button 512. Alternatively, the publish may forgo the save or exit option and simply cut an paste the code 511 into the source code of the web page they want to feature the button.

In FIG. 5B, a browser presents an interface 520 for viewing a page of the publishing that features the button as created in FIG. 5A. By way of example, the publisher is a developer of an application referred to as SuperShopper+. The content to be provided to users who access the page 520 is by a content provider referred to as PHONEMAKER CO. Under this scenario, PHONEMAKER CO. hosts content for enabling execution of the SuperShopper+ application via a particular device known as Device Type A that they manufacture. The interactive button 515 as created is shown. Upon selection of this button, a sub-element of the page 520 is presented as shown in FIG. 5C as a modal window 517.

The modal window 517 includes various information regarding the content to be downloaded, and is offered to the interface as a preview to the user. The information includes an icon 519, pricing information 523, a product description 521 and rating information 525. Also presented are action buttons for facilitating the particular download option. By way of example, the Download on Mobile action button 527 facilitates an over-the-air download while the Download on PC action button 529 facilitates a download via an intermediate device (e.g., a PC or friend's device). While not shown, at least one of the action buttons 527 or 529 may be masked out to prevent selection depending on the determined connectivity status of the requesting device and/or the intermediate device.

The exemplary embodiments herein enables a developer to automatically generate a an interactive element and embed it into a web page to facilitate a download of content to one or more devices within the same web page context. It is also contemplated, however, in future embodiments that the content access module 111 may be configured to support the uploading of content by way of the interaction of the one or more modules described herein.

The processes described herein for enabling users to download third party content within the same web page context may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

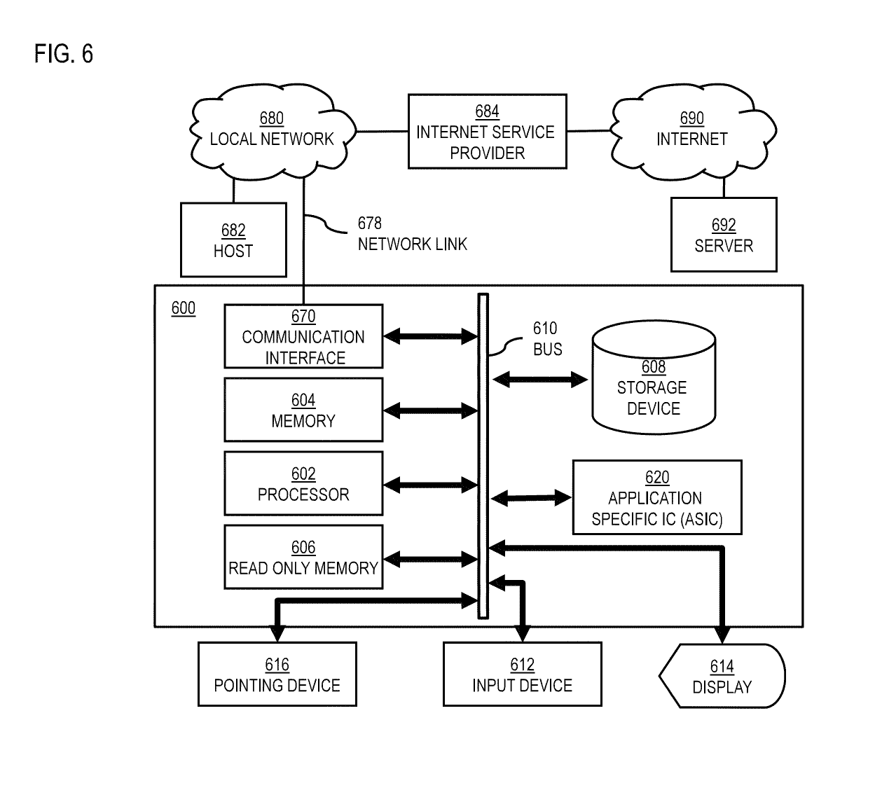

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to enable users to download third party content within the same web page context as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of enabling users to download third party content within the same web page context.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to enable users to download third party content within the same web page context. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for enabling users to download third party content within the same web page context. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for enabling users to download third party content within the same web page context, is provided to the bus 610 for use by the processor from an external input device 612, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for enabling users to download third party content within the same web page context to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to enable users to download third party content within the same web page context as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of enabling users to download third party content within the same web page context.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to enable users to download third party content within the same web page context. The memory 705 also stores the data associated with or generated by the execution of the inventive steps.

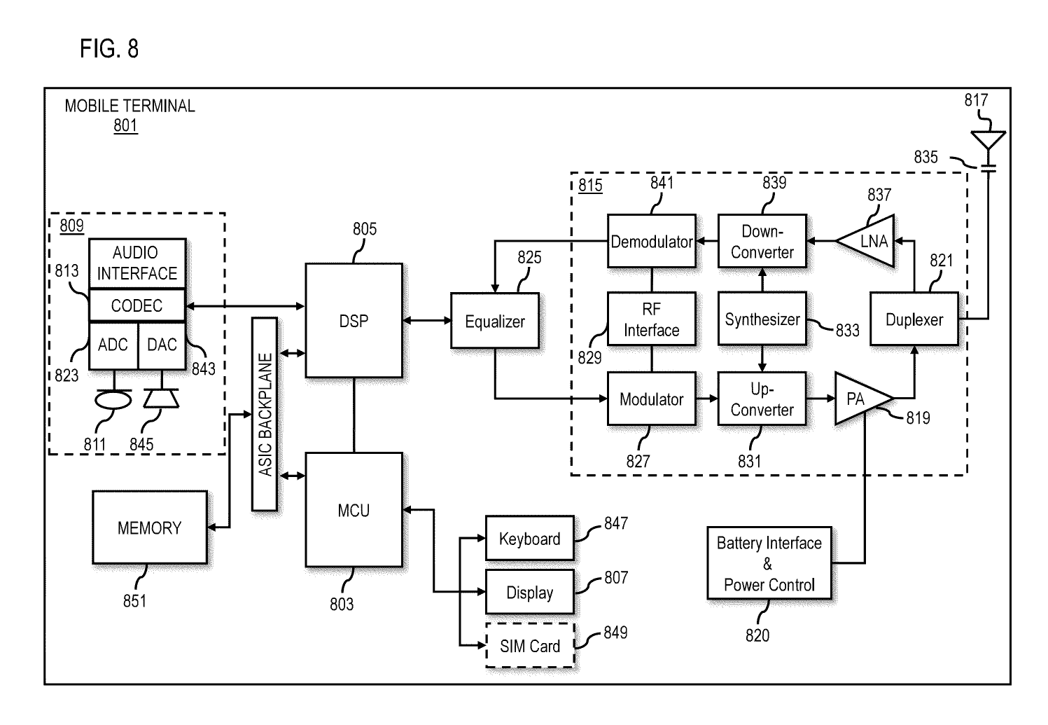

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of enabling users to download third party content within the same web page context. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of enabling users to download third party content within the same web page context. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to enable users to download third party content within the same web page context. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a request for causing, at least in part, a downloading of content associated with a webpage rendered at a device, wherein the content is hosted at at least one content store;
a rendering of information associated with the content, the downloading of the content, or a combination thereof from the at least one content store as a sub-element of the webpage; and
at least one determination to cause, at least in part, the downloading of the content to the device, one or more other devices, or a combination thereof within a context of the webpage.

2. A method of claim 1, wherein the (1) data and/or (2) information and/or (3) at least one signal are further based, at least in part, on the following:
another request to generate an interactive user interface element for initiating the request for causing, at least in part, the downloading of the content from the at least one content store,
wherein the interactive user interface element is inserted into the webpage.

3. A method of claim 2, wherein the interactive user interface element includes, at least in part, code for (a) a linking to the content in the content store; (b) rendering one or more user interface elements to indicate the linking; or (c) a combination thereof.

4. A method of claim 1, wherein the (1) data and/or (2) information and/or (3) at least one signal are further based, at least in part, on the following:
connectivity information indicating one or more available connections among the device, the one or more other devices, the at least one content store, or a combination thereof; and
a processing of the connectivity information to determine a connection type for the downloading of the content.

5. A method of claim 1, wherein the (1) data and/or (2) information and/or (3) at least one signal are further based, at least in part, on the following:
a presentation of at least one push notification associated with the content, the downloading of the content, or a combination thereof at the device; and
an establishment of an over-the-air connection between the device, the one or more other devices, or a combination thereof and the content store,
wherein the downloading of the content is via the over-the-air connection.

6. A method of claim 1, wherein the (1) data and/or (2) information and/or (3) at least one signal are further based, at least in part, on the following:
an establishment of a direct connection between the device, the one or more other devices, or a combination thereof and at least one intermediate device,
wherein the at least one intermediate device downloads the content from the at least one content store and causes, at least in part, a transfer of the content to the device, the one or more other devices, or a combination thereof from the intermediate device via the direct connection.

7. A method of claim 1, wherein the (1) data and/or (2) information and/or (3) at least one signal are further based, at least in part, on the following:
a validation, an authentication, or a combination thereof of the webpage, the content, the at least one content store, or combination thereof,
wherein downloading of the content is based, at least in part, on the validation, the authentication, or a combination thereof.

8. A method of claim 7, wherein the (1) data and/or (2) information and/or (3) at least one signal are further based, at least in part, on the following:
a comparison of the webpage, the content, the at least one content store, or a combination thereof to one or more blacklists, one or more whitelists, or a combination thereof,
wherein the validation, the authentication, or a combination thereof is based, at least in part, on the comparison.

9. A method of claim 1, wherein the (1) data and/or (2) information and/or (3) at least one signal are further based, at least in part, on the following:
at least one determination of status information of the downloading, an installation, or a combination thereof of the content at the device, the one or more other devices, or a combination thereof; and
a closing of the sub-element based, at least in part, on the status information.

10. A method of claim 1, wherein the sub-element is a modal dialog rendered in at least one frame of the webpage.

11. An apparatus comprising:
at least one processor; and
at least one memory including computer program code for one or more programs,
the at least one memory and the computer program code configured to, with the at least one processor, cause the apparatus to perform at least the following,
determine a request for causing, at least in part, a downloading of content associated with a webpage rendered at a device, wherein the content is hosted at at least one content store;
cause, at least in part, a rendering of information associated with the content, the downloading of the content, or a combination thereof from the at least one content store as a sub-element of the webpage; and
determine to cause, at least in part, the downloading of the content to the device, one or more other devices, or a combination thereof within a context of the webpage.

12. An apparatus of claim 11, further comprising:
determine another request to generate an interactive user interface element for initiating the request for causing, at least in part, the downloading of the content from the at least one content store,
wherein the interactive user interface element is inserted into the webpage.

13. An apparatus of claim 12, wherein the interactive user interface element includes, at least in part, code for (a) a linking to the content in the content store; (b) rendering one or more user interface elements to indicate the linking; or (c) a combination thereof.

14. An apparatus of claim 11, further comprising:
determine connectivity information indicating one or more available connections among the device, the one or more other devices, the at least one content store, or a combination thereof; and
process and/or facilitate a processing of the connectivity information to determine a connection type for the downloading of the content.

15. An apparatus of claim 11, further comprising:
cause, at least in part, a presentation of at least one push notification associated with the content, the downloading of the content, or a combination thereof at the device; and
cause, at least in part, an establishment of an over-the-air connection between the device, the one or more other devices, or a combination thereof and the content store,
wherein the downloading of the content is via the over-the-air connection.

16. An apparatus of claim 11, further comprising:
cause, at least in part, an establishment of a direct connection between the device, the one or more other devices, or a combination thereof and at least one intermediate device,
wherein the at least one intermediate device downloads the content from the at least one content store and causes, at least in part, a transfer of the content to the device, the one or more other devices, or a combination thereof from the intermediate device via the direct connection.

17. An apparatus of claim 11, further comprising:
cause, at least in part, a validation, an authentication, or a combination thereof of the webpage, the content, the at least one content store, or combination thereof,
wherein downloading of the content is based, at least in part, on the validation, the authentication, or a combination thereof.

18. An apparatus of claim 17, further comprising:
cause, at least in part, a comparison of the webpage, the content, the at least one content store, or a combination thereof to one or more blacklists, one or more whitelists, or a combination thereof,
wherein the validation, the authentication, or a combination thereof is based, at least in part, on the comparison.

19. An apparatus of claim 11, further comprising:
determine status information of the downloading, an installation, or a combination thereof of the content at the device, the one or more other devices, or a combination thereof; and
cause, at least in part, a closing of the sub-element based, at least in part, on the status information.

20. An apparatus of claim 11, wherein the sub-element is a modal dialog rendered in at least one frame of the webpage.
